(19) United States
(12) Patent Application Publication
(10) Pub. No.: US 2015/0309296 A1
(43) Pub. Date: Oct. 29, 2015

(54) PHASE CONTRAST MICROSCOPE, CONTROL APPARATUS FOR PHASE CONTRAST MICROSCOPE, AND CONTROL METHOD FOR PHASE CONTRAST MICROSCOPE

(71) Applicant: Sony Corporation, Tokyo (JP)

(72) Inventors: Suguru Dowaki, Kanagawa (JP); Hirokazu Tatsuta, Kanagawa (JP)

(73) Assignee: SONY CORPORATION, Tokyo (JP)

(21) Appl. No.: 14/647,505

(22) PCT Filed: Oct. 29, 2013
(86) PCT No.: PCT/JP2013/006390

§ 371 Date: May 27, 2015

(30) Foreign Application Priority Data
Dec. 14, 2012 (JP) 2012-273366

(51) Int. Cl. G02B 21/14; G02B 21/36

(52) U.S. Cl. CPC G02B 21/14; G02B 21/365

(57) ABSTRACT

To provide a phase contrast microscope capable of overcoming an optical effect of an observation target on a phase contrast image, a control apparatus for a phase contrast microscope, and a control method for a phase contrast microscope.

[Solving Means] A phase contrast microscope according to the present technology includes a phase ring, an opening ring, and a condenser lens. The opening ring is movable in a first direction with respect to the phase ring. The condenser lens is movable in the first direction with respect to the phase ring independently from the opening ring.

### TECHNICAL FIELD

The present technology relates to a phase contrast microscope capable of capturing a phase contrast image of an observation target, to a control apparatus for a phase contrast microscope, and to a control method for a phase contrast microscope.

### BACKGROUND ART

A phase contrast microscope capable of generating a phase contrast image of an observation target includes an opening ring and a phase ring as characteristic components. The opening ring is a light shielding plate in which an annular slit is formed. The phase ring is a transparent plate including an annular phase film.

Illumination light (uniform light) emitted from a light source passes through the slit of the opening ring, shaped into a ring shape, and collected to the observation target through a condenser lens (light collection lens). Here, the illumination light is divided into direct light that straight travels through the observation target and diffracted light diffracted by the observation target.

The direct light passes through the phase film of the phase ring such that the phase is shifted and the light is reduced. Most part of the diffracted light passes through a transparent portion (portion in which phase film is not formed) of the phase ring. Thus, the phase and the brightness are not changed. An image of the direct light and the diffracted light is formed in the same imaging surface by an imaging lens. Thus, a phase contrast image is generated.

With the configuration of the phase contrast microscope, in order to obtain a favorable phase contrast image, a conjugate relationship between the opening ring and the phase ring is necessary. Therefore, before the observation target is observed, the opening ring and the phase ring are aligned at an observation magnification. For example, Patent Document 1 has disclosed a phase contrast microscope capable of moving either one of a first phase ring (opening ring) and a second phase ring.

Patent Document 1: Japanese Patent Application Laid-open No. 2009-122356

### SUMMARY OF INVENTION

### Problem to be Solved by the Invention

However, the observation target set by the phase contrast microscope may affect the conjugate relationship between the opening ring and the phase ring. For example, if the observation target contains liquid, the conjugate relationship is lost due to a lens effect of the liquid and it becomes difficult to obtain a favorable phase contrast image.

In view of the above-mentioned situation, it is an object of the present technology to provide a phase contrast microscope capable of overcoming an optical effect of an observation target on a phase contrast image, a control apparatus for a phase contrast microscope, and a control method for a phase contrast microscope.

### Means for Solving the Problem

In order to achieve the above-mentioned object, a phase contrast microscope according to an embodiment of the present technology includes a phase ring, an opening ring, and a condenser lens. The opening ring is movable in a first direction with respect to the phase ring. The condenser lens is movable in the first direction with respect to the phase ring independently from the opening ring.

With this configuration, even if the conjugate relationship between the opening ring and the phase ring is lost due to the lens effect of the liquid surface of the observation target, independently adjusting the position of the opening ring with respect to the phase ring and the position of the condenser lens with respect to the phase ring makes it possible to establish the conjugate relationship while keeping the magnification. That is, it becomes possible to put the phase contrast microscope in a state suitable for observing the phase contrast image. On the contrary, when only the position of the opening ring with respect to the phase ring is adjusted, the magnification is changed due to the lens effect of the liquid surface, and hence a favorable phase contrast image cannot be obtained.

The opening ring may be further movable in a second direction orthogonal to the first direction and movable in a third direction orthogonal to the first direction and the second direction.

With this configuration, it is possible to align the opening ring and the phase ring in the second direction and the third direction. Although optical centers of the opening ring and the phase ring may be deviated due to the lens effect of the liquid surface of the observation target, the above-mentioned configuration can overcome such a deviation.

The phase contrast microscope may further include: an imaging section that captures an adjustment image including an opening ring image that is an image of the opening ring and a phase ring image that is an image of the phase ring; and a control unit that adjusts, based on the adjustment image, a position of the opening ring with respect to the phase ring and a position of the condenser lens with respect to the phase ring.

With this configuration, the control unit adjusts the positions of the opening ring and the condenser lens with respect to the phase ring based on the adjustment image, and hence it becomes possible to automatically put the phase contrast microscope in a state suitable for observing the phase contrast image.

The control unit may adjust the position of the opening ring such that focusing of the opening ring image is achieved, and adjust the position of the condenser lens such that the opening ring image is within the phase ring image.

This configuration makes it possible for the control unit to adjust the position of the opening ring with respect to the phase ring by utilizing focus of the opening ring image and adjust the position of the condenser lens with respect to the phase ring by utilizing a size relationship between the opening ring image and the phase ring image.

In order to achieve the above-mentioned object, a control apparatus for a phase contrast microscope according to an embodiment of the present technology includes: obtaining an adjustment image including an opening ring image that is an image of an opening ring and a phase ring image that is an image of a phase ring; and adjusting, based on the adjustment image, a position of the opening ring with respect to the phase ring and a position of the condenser lens with respect to the phase ring.

In order to achieve the above-mentioned object, a control method for a phase contrast microscope according to an embodiment of the present technology includes adjusting, based on an adjustment image including an opening ring image that is an image of an opening ring and a phase ring image that is an image of a phase ring, a position of the opening ring with respect to the phase ring and a position of a condenser lens with respect to the phase ring.

### Effect of the Invention

As described above, according to the present technology, it is possible to provide a phase contrast microscope capable of overcoming an optical effect of an observation target on a phase contrast image, a control apparatus for a phase contrast microscope, and a control method for a phase contrast microscope.

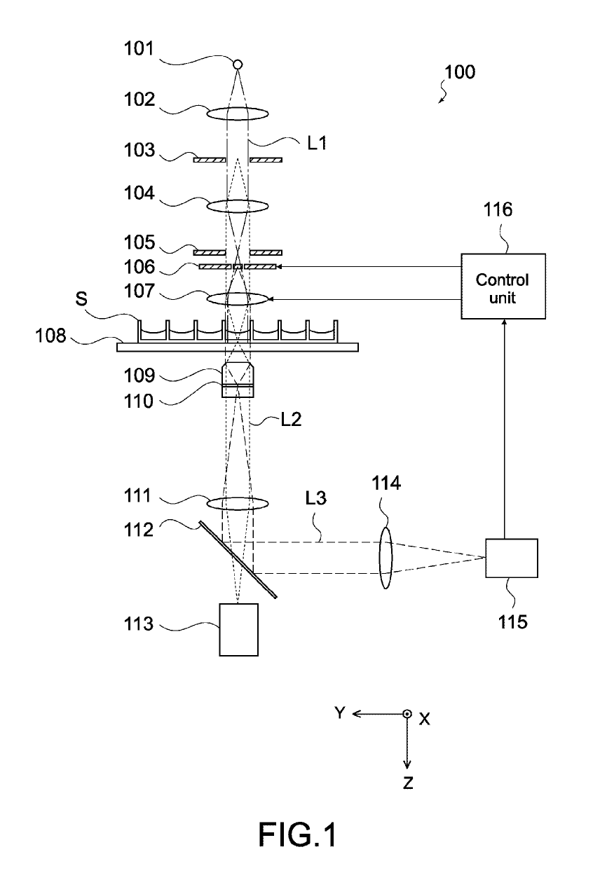

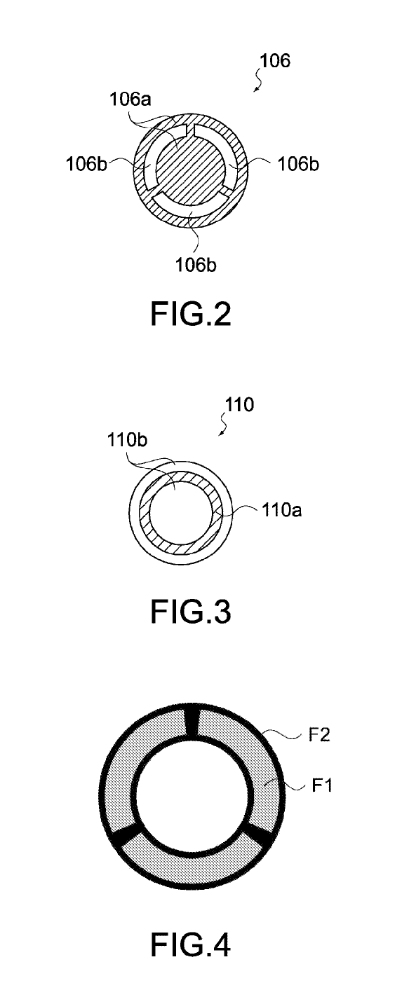

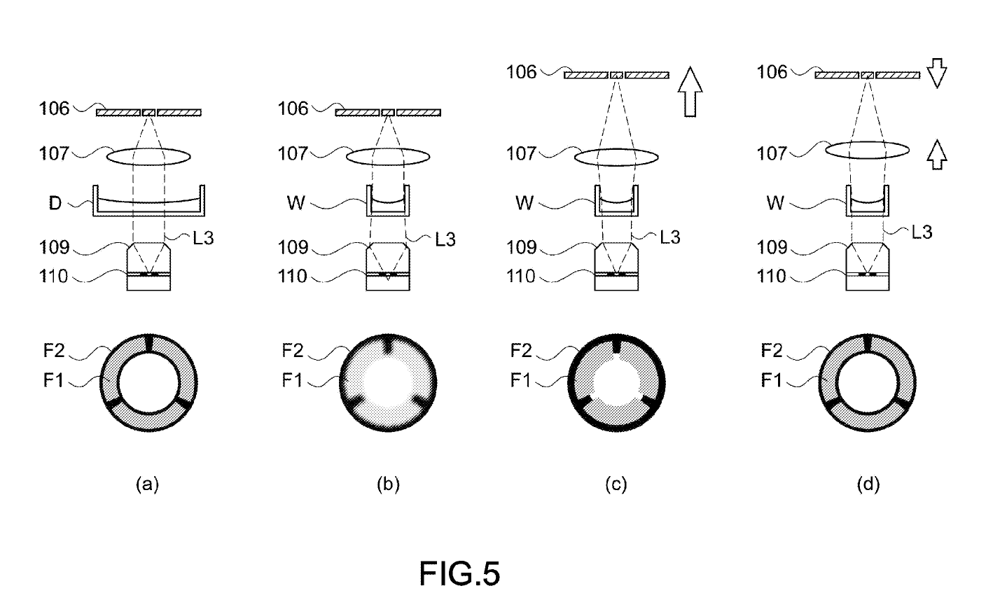

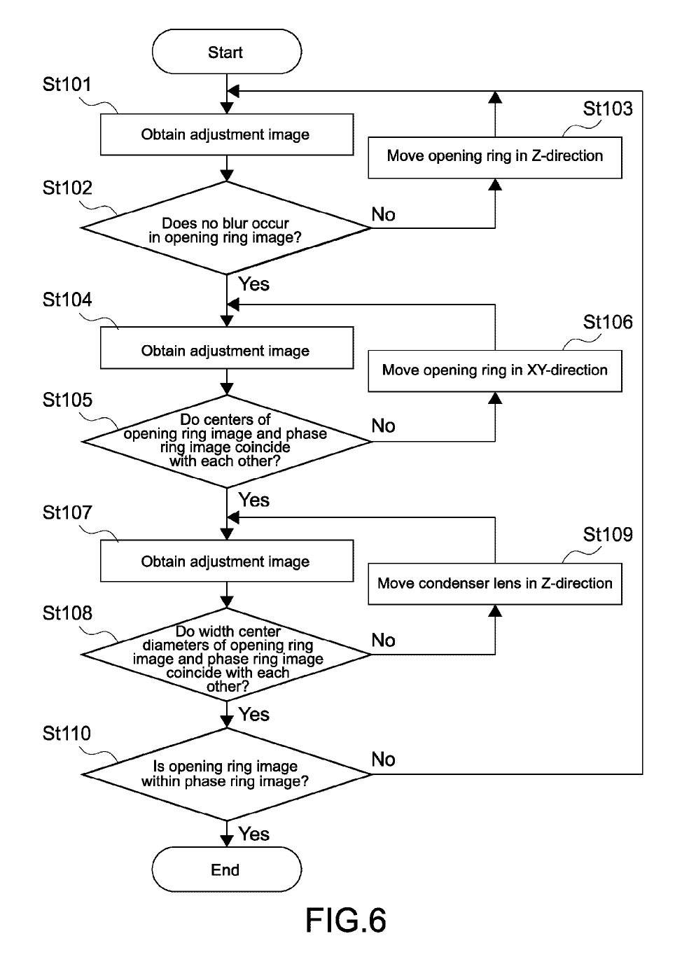

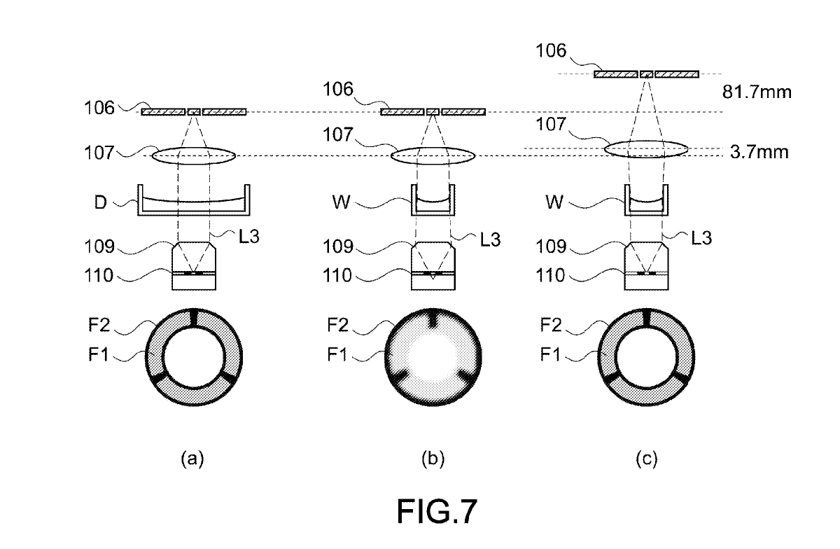

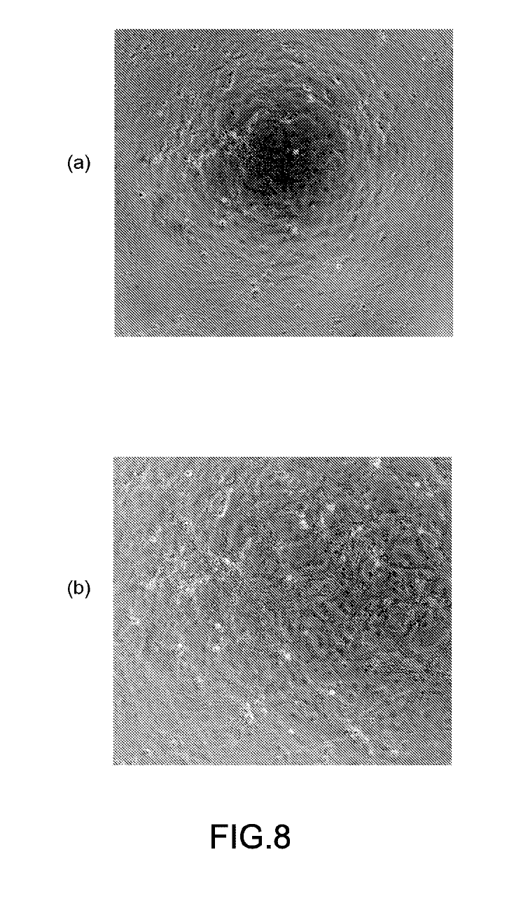

### BRIEF DESCRIPTION OF DRAWINGS

[FIG. 1] A schematic diagram of a phase contrast microscope according to an embodiment of the present technology.

[FIG. 2] A schematic diagram of an opening ring of the phase contrast microscope.

[FIG. 3] A schematic diagram of a phase ring of the phase contrast microscope.

[FIG. 4] An example of an adjustment image captured by a second imaging section of the phase contrast microscope.

[FIG. 5] A schematic diagram showing adjustment of the opening ring and the condenser lens of the phase contrast microscope.

[FIG. 6] A flowchart showing an operation of a control unit of the phase contrast microscope.

[FIG. 7] Examples of a movement amount of a condenser lens of the opening ring of the phase contrast microscope.

[FIG. 8] Examples of a phase contrast image captured by a first imaging section of the phase contrast microscope.

### MODE(S) FOR CARRYING OUT THE INVENTION

A phase contrast microscope according to an embodiment of the present technology will be described.

[Configuration of Phase Contrast Microscope]

FIG. 1 is a schematic diagram showing a configuration of a phase contrast microscope 100 according to this embodiment. As shown in the figure, the phase contrast microscope 100 includes a light source 101, a light source lens 102, a field stop 103, a relay lens 104, an opening stop 105, an opening ring 106, a condenser lens 107, a stage 108, an objective 109, a phase ring 110, a first imaging lens 111, a mirror 112, a first imaging section 113, a second imaging lens 114, a second imaging section 115, and a control unit 116. Further, a well plate S that houses an observation target (cell or the like in culture solution) is placed on the stage 108.

In the following description, it is assumed that a direction from the opening ring 106 to the phase ring 110 is a Z-direction, a direction perpendicular to the Z-direction is an X-direction, and a direction perpendicular to the Z-direction and the X-direction is a Y-direction. The Z-direction corresponds to an optical axis direction of the phase contrast microscope 100. The X-direction and the Y-direction are directions along a stage surface of the stage 108.

The light source 101 is a light source that generates illumination light emitted to the observation target and any light source such as a halogen lamp and a white LED (Light Emitting Diode) can be used. In FIG. 1, an optical path of illumination light emitted from the light source 101 is shown as an optical path L1.

The light source lens 102 is a lens that collects illumination light emitted from the light source 101. Although anything can be used as the light source lens 102, one capable of changing illumination light into uniform light (Kohler illumination light) is favorable.

The field stop 103 is located to conjugate with the observation target. The field stop 103 limits a range in which the observation target is irradiated with illumination light. The field stop 103 can be, for example, a light shielding plate in which a circular opening is formed.

The relay lens 104 is a lens that transmits the illumination light. Anything can be used as the relay lens 104.

The opening stop 105 is located to conjugate with the light source 101. The opening stop 105 adjusts the amount of illumination light emitted to the observation target. The opening stop 105 can be, for example, a light shielding plate in which a circular opening is formed.

The opening ring 106 shapes illumination light into a ring shape. FIG. 2 is a schematic diagram showing the opening ring 106. As shown in the figure, the opening ring 106 includes a light shielding region 106a and light transmissive regions 106b. The light shielding region 106a is a region for shielding incident light. The light transmissive regions 106b are regions for transmitting incident light. The opening ring 106 may be obtained by forming slits in a light-shielding member as the light transmissive regions 106b and setting the remaining region as the light shielding region 106a.

Here, the opening ring 106 is configured to be movable at least in the Z-direction with respect to the phase ring 110. Although described later in detail, the opening ring 106 is favorably configured to be movable also in the X-direction and the Y-direction.

In addition, the opening ring 106 can be moved by a driving mechanism (not shown), for example, a motor in respective directions. The driving mechanism may be connected to and controlled by the control unit 116. That is, the position of the opening ring 106 can be adjusted by the control unit 116. Alternatively, the position of the opening ring 106 may be manually adjusted.

The condenser lens 107 is a lens that collects illumination light to the observation target. Anything can be used as the condenser lens 107. Here, the condenser lens 107 is configured to be movable in the Z-direction with respect to the phase ring 110 independently from the opening ring 106.

In addition, the condenser lens 107 may be moved by a driving mechanism (not shown), for example, a motor in the Z-direction. The driving mechanism is connected to and controlled by the control unit 116. That is, the position of the condenser lens 107 may be adjusted by the control unit 116. The position of the condenser lens 107 may be manually adjusted.

The stage 108 supports the observation target (here, well plate S). The stage 108 is configured to be movable in the X-direction, the Y-direction, and the Z-direction by a driving mechanism (not shown). Note that at least a center portion of the stage 108 is formed of a light transmissive material.

The objective 109 magnifies an image of the observation target at a predetermined magnification. The objective 109 can be selected from among those at various magnifications according to a desired magnification.

The phase ring 110 shifts the phase of part of incident light. As shown in FIG. 1, although the phase ring 110 is typically integrated with the objective 109, it is independent from the objective 109. FIG. 3 is a schematic diagram showing the phase ring 110. As shown in the figure, the phase ring 110 includes a phase shift region 110a and light transmissive regions 110b. The phase shift region 110a is a region for shifting the phase of incident light and reducing incident light. The light transmissive regions 110b are regions for transmitting incident light without shifting the phase of the incident light. The phase ring 110 can be obtained by forming a phase film on a light transmissive member as the phase shift region 110a and setting the remaining regions as the light transmissive regions 110b.

The first imaging lens 111 forms an image of the observation target in an imaging surface (imaging element) of the first imaging section 113. Anything can be used as the first imaging lens 111.

The mirror 112 is disposed in an optical path between the first imaging lens 111 and the first imaging section 113. The mirror 112 reflects incident light to the second imaging lens 114. The mirror 112 may be removed from the optical path when observing the phase contrast image.

The first imaging section 113 captures the phase contrast image of the observation target. Specifically, the first imaging section 113 can include imaging elements such as a CCD (Charge Coupled Device) and a CMOS (Complementary Metal Oxide Semiconductor).

The objective 109, the phase ring 110, the first imaging lens 111, and the first imaging section 113 constitute a first imaging optical system. In FIG. 1, the optical path of the first imaging optical system is shown as an optical path L2. The observation target and the imaging surface of the first imaging section 113 establish the conjugate relationship. The first imaging section 113 captures a phase contrast image of the observation target.

The second imaging lens 114 forms an image of light reflected by the mirror 112 in an imaging surface (imaging element) of the second imaging section 115. Anything can be used as the second imaging lens 114.

The second imaging section 115 captures an image for adjusting the positions of the opening ring 106 and the condenser lens 107 (hereinafter, referred to as adjustment image). Specifically, the second imaging section 115 can include an imaging element such as a CCD and a CMOS. The second imaging section 115 supplies the captured adjustment image to the control unit 116. Note that an optical system may be provided instead of the second imaging section 115 such that the user can view an image that equates the adjustment image.

The opening ring 106, the condenser lens 107, the objective 109, the phase ring 110, the first imaging lens 111, the mirror 112, the second imaging lens 114, and the second imaging section 115 constitute a second imaging optical system. In FIG. 1, the optical path of the second imaging optical system is shown as an optical path L3. The opening ring 106, the phase ring 110, and the imaging surface of the second imaging section 115 establish the conjugate relationship. The second imaging section 115 captures an image (adjustment image) including an image of the opening ring 106 and an image of the phase ring 110.

The control unit 116 is an information processing unit incorporated in the phase contrast microscope 100 or an information processing apparatus (PC, etc.) independent from the phase contrast microscope 100. The control unit 116 is connected to the second imaging section 115, the driving mechanism of the opening ring 106, and the driving mechanism of the condenser lens 107. Alternatively, the control unit 116 may be connected also to the driving mechanism or the like of the stage 108. The control unit 116 adjusts, based on the adjustment image supplied from the second imaging section 115, a position of the opening ring 106 with respect to the phase ring 110 and a position of the phase ring 110 with respect to the condenser lens 107. Details of the control unit will be described later.

The phase contrast microscope 100 has the above-mentioned configuration. The illumination light emitted from the light source 101 is collected by the light source lens 102. An irradiation range thereof is limited by the field stop 103. In addition, it is transmitted by the relay lens 104. The light amount is adjusted by the opening stop 105. In addition, it is transmitted through the light transmissive regions 106b (see FIG. 2) of the opening ring 106 and shaped into a ring shape. It is emitted through the condenser lens 107 to the observation target contained in a well of the well plate S.

Here, the illumination light is divided into direct light that has travelled straight through the observation target and diffracted light that has been diffracted by the observation target. The direct light is transmitted through the phase shift region 110a (see FIG. 3) of the phase ring 110. The phase is shifted and the light is reduced. Most part of the diffracted light is transmitted through the light transmissive regions 110b of the phase ring 110. Thus, the phase and the brightness are not changed. An image of the direct light and the diffracted light is formed in the imaging surface of the first imaging section 113 by the first imaging lens 111 in the optical path L2. Thus, a phase contrast image is generated.

With the configuration of the phase contrast microscope 100, in order to obtain a favorable phase contrast image, the conjugate relationship between the opening ring 106 and the phase ring 110 is necessary. Therefore, when observing the observation target, it is necessary to adjust a relative position between the opening ring 106 and the phase ring 110.

In this position adjustment, the optical path L3 is used. An image of the opening ring 106 and an image of the phase ring 110 are formed in the imaging surface of the second imaging section 115 by the second imaging lens 114 in the optical path L3. Thus, an adjustment image is generated.

FIG. 4 is a schematic diagram showing an example of the position adjustment image. As shown in the figure, the adjustment image includes an image F1 of the opening ring 106 (hereinafter, referred to as opening ring image) and an image F2 of the phase ring 110 (hereinafter, referred to as phase ring image). Here, as shown in FIG. 4, the position of the opening ring 106 with respect to the phase ring 110 is adjusted such that an opening ring image F1 is within a phase ring image F2. When the adjustment image is as such, the illumination light that has been transmitted through the light transmissive regions 106b of the opening ring 106 is transmitted through the phase shift region 110a of the phase ring 110. That is, the opening ring 106 and the phase ring 110 are in a positional relationship suitable for generating the phase contrast image.

[Lens Effect of Liquid Surface]

As described above, the relative position between the opening ring 106 and the phase ring 110 can be adjusted utilizing the adjustment image. However, a lens effect caused by an observation target affects the conjugate relationship between the opening ring 106 and the phase ring 110.

FIG. 5 is a schematic diagram showing some of components of the phase contrast microscope 100 and an adjustment image captured by the second imaging section 115.

FIG. 5(a) shows a case where the observation target includes a solution contained in a dish D. In this case, a liquid surface of a solution is close to a plane and no lens effect occurs. Therefore, the conjugate relationship between the opening ring 106 and the phase ring 110 is maintained. Thus, an adjustment image in which the opening ring image F1 is within the phase ring image F2 is generated.

FIG. 5(b) shows a case where the observation target includes a solution contained in a well W. In this case, the liquid surface of the solution forms a meniscus shape due to surface tension and the lens effect occurs. Therefore, due to the lens effect, the conjugate relationship between the opening ring 106 and the phase ring 110 is lost. A blur occurs in the opening ring image F1.

As shown in FIG. 5(c), when the opening ring 106 is moved in the Z-direction, the blur of the opening ring image F1 is overcome. However, the magnification is still unsuitable, and hence the opening ring image F1 is not within the phase ring image F2.

Here, as shown in FIG. 5(d), in addition to the opening ring 106, moving the condenser lens 107 in the Z-direction makes it possible to keep the magnification and maintain the conjugate relationship. With this, the adjustment image in which the opening ring image F1 is within the phase ring image F2 is generated. That is, it becomes possible to overcome the influence of the lens effect of the liquid.

In this manner, in the phase contrast microscope 100 according to this embodiment, the opening ring 106 and the condenser lens 107 are configured to be independently movable in the Z-direction with respect to the phase ring 110. Thus, it becomes possible to overcome the influence of the lens effect of the observation target.

[Position Adjustment of Control Unit]

The above-mentioned position adjustment of the opening ring 106 and the condenser lens 107 with respect to the phase ring 110 may be automatically performed by the control unit 116. FIG. 6 is a flowchart showing an operation of the control unit 116.

First, the control unit 116 obtains an adjustment image from the second imaging section 115 (St101). As described above, the adjustment image includes the opening ring image F1 and the phase ring image F2 (see FIG. 5).

The control unit 116 judges whether or not no blur occurs in the opening ring image F1 in the adjustment image (St102). The control unit 116 is capable of judging whether or not no blur occurs in the opening ring image F1 by performing image processing such as binarization on the adjustment image.

In the adjustment image, if no blur occurs in the opening ring image F1 (St102: Yes), the control unit 116 proceeds to the subsequent step. On the other hand, as shown in FIG. 5(b), if the blur occurs in the opening ring image F1 (St102: No), the control unit 116 controls the driving mechanism of the opening ring 106 to move the opening ring 106 in the Z-direction (St103).

The control unit 116 obtains the adjustment image again (St101) and judges whether or not no blur occurs in the opening ring image F1 (St102). If the blur occurs, the opening ring 106 is further moved in the Z-direction (St103). After that, the control unit 116 repeats the steps (St101 to 103) until the blur of the opening ring image F1 is overcome.

Subsequently, the control unit 116 obtains the adjustment image from the second imaging section 115 again (St104) and judges whether or not centers (ring centers) of the opening ring image F1 and the phase ring image F2 coincide with each other (St105). If the centers of those images coincide with each other (St105: Yes), the control unit 116 transitions to the subsequent step. On the other hand, if the centers of the images do not coincide with each other (St105: No), the control unit 116 controls the driving mechanism of the opening ring to move the opening ring 106 in the X-direction and the Y-direction (St106).

The control unit 116 obtains the adjustment image again (St104). The control unit 116 judges whether or not the centers of the opening ring image F1 and the phase ring image F2 coincide with each other (S105). If they do not coincide with each other, the opening ring 106 is further moved (St106). After that, the control unit 116 repeats the steps (St104 to 106) until the centers of the images coincide with each other.

Subsequently, the control unit 116 obtains the adjustment image from the second imaging section 115 again (St107). The control unit 116 judges whether or not width center diameters of the opening ring image F1 and the phase ring image F2 coincide with each other (St108). The diameter of the width center means a distance from the center of each ring to a center of a width of the ring in the adjustment image.

If the width center diameters of the opening ring image F1 and the phase ring image F2 coincide with each other (St108: Yes), the control unit 116 proceeds to the subsequent step. On the other hand, if the width center diameters do not coincide with each other (St108: No), the control unit 116 controls the driving mechanism of the condenser lens 107 to move the condenser lens 107 in the Z-direction (St109).

The control unit 116 obtains the adjustment image again (St107). The control unit 116 judges whether or not the width center diameters of the opening ring image F1 and the phase ring image F2 coincide with each other (St108). If they do not coincide with each other, the condenser lens 107 is further moved. After that, the control unit 116 repeats the steps (St107 to 109) until the width center diameters coincide with each other.

Subsequently, the control unit 116 judges whether or not the phase ring image F2 is within the opening ring image F1 in the adjustment image (St110). As shown in FIG. 5(d), if the opening ring image F1 is within the phase ring image F2 (St110: Yes), the control unit 116 terminates the position adjustment process. On the other hand, if the opening ring image F1 is not within the phase ring image F2 (St110: No), the control unit 116 returns the step 101 and repeats the above-mentioned steps.

In the above-mentioned manner, the control unit 116 adjusts the positions of the opening ring 106 and the condenser lens 107 with respect to the phase ring 110 in order to obtain the adjustment image as shown in FIG. 5(d). With this, it becomes possible to overcome the influence of the lens effect by the observation target and maintain the conjugate relationship between the opening ring 106 and the phase ring 110.

Note that the procedure of the above-mentioned position adjustment may be carried out not by the control unit 116 but by a user. That is, the optical system that can be viewed instead of the second imaging section 115 may be utilized such that the user can adjust the positions of the opening ring 106 and the condenser lens 107.

### EXAMPLE

In the phase contrast microscope 100, when performing the position adjustment of the opening ring 106 and the condenser lens 107 as described above, a distance by which it has to be moved is calculated. FIG. 7 is a schematic diagram showing some of the components of the phase contrast microscope 100 and a movement distance.

FIG. 7(a) shows a state in which an observation target includes a solution contained in the dish D and no lens effect of the solution occurs. FIG. 7(b) shows a state in which an observation target includes a container housed in the well W and the lens effect of the solution occurs. FIG. 7(c) shows a state in which the positions of the opening ring 106 and the condenser lens 107 with respect to the phase ring 110 are adjusted from the state shown in FIG. 7(b).

It is assumed that a center thickness of the solution (absolute refractive index n=1.33) is 3 mm, a curvature radius of the meniscus of the solution surface is 8 mm, and the focal distance of the condenser lens 107 is 45 mm. In this case, as shown in FIG. 7(c), when the movement distance of the opening ring 106 in the Z-direction is 81.7 mm and the movement distance of the condenser lens 107 in the Z-direction 3.7 mm, the conjugate relationship between the opening ring 106 and the phase ring 110 is established and a state suitable for generating the phase contrast image is obtained.

When the well W is moved in the XY-direction by 2 mm, that is, the meniscus is decentered by 2 mm, if the movement distance of the opening ring 106 in the XY-direction is 3.8 mm and the movement distance in the Z-direction is 22 mm, the conjugate relationship between the opening ring 106 and the phase ring 110 is established and a state suitable for generating the phase contrast image is obtained.

FIG. 8 shows phase contrast images of an observation target that are captured by the first imaging section 113 of the phase contrast microscope 100. FIG. 8(a) shows the phase contrast image in a state in which the conjugate relationship between the opening ring 106 and the phase ring 110 is lost (see FIG. 7(b)) due to the lens effect of the liquid surface. FIG. 8(b) shows the phase contrast image in a state in which the positions of the opening ring 106 and the condenser lens 107 are adjusted and the conjugate relationship between the opening ring 106 and the phase ring 110 is maintained (see FIG. 7(c)). Note that the observation target was a human cardiac muscle cell derived from an iPS cell fixed in a culture solution and an optical magnification was 10 times (C-labo. TE200). As the first imaging section 113, a CMOS (Complementary Metal Oxide Semiconductor) camera of 2048*2048 pixels was used.

As shown in FIG. 8(a), in the state in which the conjugate relationship is lost, regions in which the phase contrast is obtained are only in a center portion of the image. On the other hand, as shown in FIG. 8(b), in the state in which the conjugate relationship is established, regions in which the phase contrast is obtained are over the image and a favorable phase contrast image is obtained. That is, as in this embodiment, it can be said that, by adjusting the positions of the opening ring 106 and the condenser lens 107 with respect to the phase ring 110, it is possible to overcome the influence of the lens effect of the liquid surface of the observation target and obtain a favorable phase contrast image.

The present technology is not limited only to the embodiments and may be changed without departing from the gist of the present technology.

Note that the present technology will also take the following configurations.

(1)

A phase contrast microscope, including:

a phase ring;

an opening ring that is movable in a first direction with respect to the phase ring; and

a condenser lens that is movable in the first direction with respect to the phase ring independently from the opening ring.

(2)

The phase contrast microscope according to (1), in which

the opening ring is further movable in a second direction orthogonal to the first direction and movable in a third direction orthogonal to the first direction and the second direction.

(3)

The phase contrast microscope according to (1) or (2), further including:

an imaging section that captures an adjustment image including an opening ring image that is an image of the opening ring and a phase ring image that is an image of the phase ring; and

a control unit that adjusts, based on the adjustment image, a position of the opening ring with respect to the phase ring and a position of the condenser lens with respect to the phase ring.

(4)

The phase contrast microscope according to any one of (1) to (3), in which

the control unit adjusts the position of the opening ring such that focusing of the opening ring image is achieved, and adjusts the position of the condenser lens such that the opening ring image is within the phase ring image.

(5)

A control apparatus for a phase contrast microscope, including:

obtaining an adjustment image including an opening ring image that is an image of an opening ring and a phase ring image that is an image of a phase ring; and

adjusting, based on the adjustment image, a position of the opening ring with respect to the phase ring and a position of the condenser lens with respect to the phase ring.

(6)

A control method for a phase contrast microscope, including:

adjusting, based on an adjustment image including an opening ring image that is an image of an opening ring and a phase ring image that is an image of a phase ring, a position of the opening ring with respect to the phase ring and a position of a condenser lens with respect to the phase ring.

### DESCRIPTION OF REFERENCE NUMERALS

100 phase contrast microscope

101 light source

102 light source lens

103 field stop

104 relay lens

105 opening stop

106 opening ring

107 condenser lens

108 stage

109 objective

110 phase ring

111 first imaging lens

112 mirror

113 second imaging section

114 second imaging lens

115 second imaging section

116 control unit

1. A phase contrast microscope, comprising:
a phase ring;
an opening ring that is movable in a first direction with respect to the phase ring; and
a condenser lens that is movable in the first direction with respect to the phase ring independently from the opening ring.

2. The phase contrast microscope according to claim 1, wherein
the opening ring is further movable in a second direction orthogonal to the first direction and movable in a third direction orthogonal to the first direction and the second direction.

3. The phase contrast microscope according to claim 1, further comprising:
an imaging section that captures an adjustment image including an opening ring image that is an image of the opening ring and a phase ring image that is an image of the phase ring; and
a control unit that adjusts, based on the adjustment image, a position of the opening ring with respect to the phase ring and a position of the condenser lens with respect to the phase ring.

4. The phase contrast microscope according to claim 3, wherein
the control unit adjusts the position of the opening ring such that focusing of the opening ring image is achieved, and adjusts the position of the condenser lens such that the opening ring image is within the phase ring image.

5. A control apparatus for a phase contrast microscope, comprising:
obtaining an adjustment image including an opening ring image that is an image of an opening ring and a phase ring image that is an image of a phase ring; and
adjusting, based on the adjustment image, a position of the opening ring with respect to the phase ring and a position of the condenser lens with respect to the phase ring.

6. A control method for a phase contrast microscope, comprising
adjusting, based on an adjustment image including an opening ring image that is an image of an opening ring and a phase ring image that is an image of a phase ring, a position of the opening ring with respect to the phase ring and a position of a condenser lens with respect to the phase ring.
